(19) United States
(12) Patent Application Publication
(10) Pub. No.: US 2023/0327123 A1
(43) Pub. Date: Oct. 12, 2023

(54) ELECTRODE SLURRY FOR ALL-SOLID-STATE BATTERIES INCLUDING CLUSTER COMPOSITE AND METHOD FOR MANUFACTURING THE SAME

(71) Applicants: Hyundai Motor Company, Seoul (KR); Kia Corporation, Seoul (KR)

(72) Inventors: Hong Suk Choi, Hwaseong, Gyeonggi-do (KR); Young Jin Nam, Suwon, Gyeonggi-do (KR); Seon Hwa Kim, Cheongju, Chungcheongbuk-do (KR); Hee Soo Kang, Seoul (KR); Jae Min Lim, Suwon, Gyeonggi-do (KR); Sang Wan Kim, Anyang, Gyeonggi-do (KR)

(73) Assignees: Hyundai Motor Company, Seoul (KR); Kia Corporation, Seoul (KR)

(21) Appl. No.: 18/075,021

(22) Filed: Dec. 5, 2022

(30) Foreign Application Priority Data
Apr. 11, 2022 (KR) 10-2022-0044325

(51) Int. Cl. H01M 4/62

(52) U.S. Cl. CPC H01M 4/623; H01M 4/625; H01M 2004/021

(57) ABSTRACT

Disclosed are an electrode slurry for all-solid-state batteries including a cluster composite in which particles of an electrode material are connected by a first binder which is a fiberized polymer, and a method for manufacturing the electrode slurry for all-solid-state batteries.

### CROSS-REFERENCE TO RELATED APPLICATION

This application claims under 35 U.S.C. § 119(a) the benefit of priority to Korean Patent Application No. 10-2022-0044325 filed on Apr. 11, 2022, the entire contents of which are incorporated herein by reference.

### TECHNICAL FIELD

The present disclosure relates to an electrode slurry for all-solid-state batteries including a cluster composite in which particles of an electrode material are connected by a first binder which is a fiberized polymer, and a method for manufacturing the electrode slurry for all-solid-state batteries.

### BACKGROUND

A lithium ion battery has several advantages, including high durability, high capacity and high energy density, and is thus applied to small-sized devices, such as smartphones, and middle-sized and large-sized devices, such as vehicles, energy storage systems (ESSs), etc. However, the lithium ion battery does not have enough capacity to store all energy corresponding to a demand. Particularly, the range of an electric vehicle is much less than that of a vehicle using an internal combustion engine. In order to solve the low capacity of the lithium ion battery, there is a method for increasing the capacity of an electrode per unit weight and volume of the electrode.

In order to increase the capacity of the electrode per unit weight and volume of the electrode, nanoscale active and conductive materials may be used, but it is difficult to commercialize such a method. Nanoscale particles have a large surface area and may thus have a large reaction compared to micro-sized particles, and have a short distance from the surfaces thereof to the centers thereof and may thus be used even though ion conductivity in the particles is reduced. However, the large surface area of the nanoscale particles is also a drawback. When the surface area is large, a large amount of a solvent is required to manufacture a slurry, and thus, it may take a long time to dry an electrode, and the composition of the slurry may be partially varied during a drying process. Further, as the surface area is increased, a large amount of a binder is also required. The nanoscale particles have very high surface energy and thus agglomerate to form secondary particles, and thus, an additional dispersant may be required to prepare a slurry. The binder and the dispersant function as resistances to migration of lithium ions, and thus reduce lithium ion conductivity in the electrode.

Recently, research on a storage-type anodeless all-solid-state battery in which an anode is removed and lithium is precipitated directly at an anode current collector has been conducted. In the anodeless all-solid-state battery, a coating layer including nanoscale metal particles, which may be sintered into a seed which assists deposition of lithium on the anode current collector, is formed. Sintering in which particles agglomerate when heat and pressure are applied thereto occurs in the metal particles, and thus, it is difficult to prepare a slurry using the metal particles. When sintering occurs while preparing the slurry, the sizes of the particles are increased, the particle sizes are not uniform due to the agglomeration of the particles, viscosity of the slurry is not uniform, and respective components are nonuniformly distributed. Further, the interface between the agglomerated particles becomes a grain boundary having poor mechanical properties. In the case in which an electrode is manufactured using the slurry, the material is damaged along the grain boundary when a cell is driven, and thus, performance of the cell is degraded.

The above information disclosed in this Background section is only for enhancement of understanding of the background of the invention and therefore it may contain information that does not form the prior art that is already known in this country to a person of ordinary skill in the art.

### SUMMARY

In preferred aspects, provided is an electrode slurry for all-solid-state batteries and a method for manufacturing the electrode slurry for all-solid-state batteries. In particular, nanoscale particles of an electrode material may be uniformly distributed without using large amounts of a solvent, a binder, a dispersant, and the like. Moreover, the electrode slurry for all-solid-state batteries may suppress sintering of nanoscale particles of an electrode material so as to increase performance of a cell.

In one aspect, provided is an electrode slurry for all-solid-state batteries including a cluster composite including a first binder including a fiberized polymer, and an electrode material, a solvent component, and a second binder.

The term “binder”, as used herein, refers to a resin or a polymeric material. In certain embodiments, the first binder may adhere the other components to each other in the cluster composite.

The cluster composite may include the electrode material including a secondary particle comprising a plurality of primary particles, and the first binder connecting the plurality of primary particle. The primary particles may have a size in a nanometer scale, e.g., the size or the diameter, which is measured by the maximum distance between two points of the particle, may range from about 1 nm to 999 nm. Alternatively, the size or the diameter of each of the primary particle is less than about 999 nm, less than about 900 nm, less than about 800 nm, less than about 700 nm, less than about 600 nm, less than about 500 nm, less than about 400 nm, less than about 300 nm, less than about 200 nm, less than about 100 nm, less than about 50 nm, less than about 30 nm, less than about 10 nm, less than about 5 nm, or less than about 1 nm. Moreover, the particle size may be represented by a median value (D50) of the diameter or size of the plurality of the primary particles. The particle size (D50) of the primary particles may range from about 1 nm to 999 nm. Alternatively, the size or the diameter (D50) the primary particles is less than about 999 nm, less than about 900 nm, less than about 800 nm, less than about 700 nm, less than about 600 nm, less than about 500 nm, less than about 400 nm, less than about 300 nm, less than about 200 nm, less than about 100 nm, less than about 50 nm, less than about 30 nm, less than about 10 nm, less than about 5 nm, or less than about 1 nm.

The electrode material may include an electrode active material.

The electrode material may suitably include a carbon material, and metal powder capable of alloying with lithium, and the metal powder may include one or more selected from the group consisting of gold (Au), platinum (Pt), palladium (Pd), silicon (Si), silver (Ag), aluminum (Al), bismuth (Bi), tin (Sn), and zinc (Zn).

The first binder may include polytetrafluoroethylene.

The cluster composite may include an amount of about 1 part by weight to 5 parts by weight of the first binder based on 100 parts by weight of the electrode material.

A particle size (D50) of the cluster composite may be about 0.5 μm to 10 μm.

The second binder may be the same to or different from the first binder. Preferably, the second binder may be the same (e.g., same chemical components) and may suitably include one or more selected from the group consisting of polyvinylidene fluoride, carboxymethyl cellulose, styrene butadiene rubber, nitrile butadiene rubber, polyacrylic acid, and alginic acid.

A mass ratio of the first binder to the second binder may be about 0.1:100 to 10:1

In another aspect, provided is a method for manufacturing an electrode slurry for all-solid-state batteries. The method may include: providing an admixture including a polymer capable of being fiberized and an electrode material; preparing a cluster composite including a first binder including a fiberized polymer and the electrode material by milling the admixture; and preparing the electrode slurry including the cluster composite, a solvent component and a second binder.

The milling the admixture may include milling of the starting material at a temperature of about 30° C. to 50° C. and a rotational speed of about 100 rpm to 2,000 rpm for about 1 minute to 120 minutes in a dry state, and cooling of the milled admixture to a temperature of about 1° C. to 30° C. Preferably, the milling and cooling may be repeated.

The term “in a dry state” as used herein refers to a state not including or affected by any solvents (e.g., water, moisture, or added solvent). Preferably, the solvent content in the substance in the dry state may be less than about 5% by weight, less than about 4% by weight, less than about 3% by weight, less than about 2% by weight, less than about 1% by weight, or less than about 0.1% by weight of its total weight.

The cooling of the admixture may include resting the resultant for about 5 minutes to 12 hours, or stirring the resultant at a rotational speed of about 100 rpm to 2,000 rpm for about 1 minute to 10 minutes.

The milling and the cooling the admixture may be repeated about 2 to 50 times.

Also provided is an all-solid-state battery including an electrode formed from the electrode slurry described herein.

Further provided is a vehicle including the all-solid-state battery described herein.

Other aspects of the disclosure are discussed infra.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present invention, and wherein:

FIG. 1 shows a portion of an exemplary electrode slurry for all-solid-state batteries according to an exemplary embodiment of the present disclosure;

FIG. 2 shows an exemplary cluster composite according to an exemplary embodiment of the present disclosure;

FIG. 3A shows a scanning electron microscope (SEM) analysis result of a cluster composite according to Comparative Example 1;

FIG. 3B shows an enlarged image of a portion of FIG. 3A;

FIG. 4A shows an SEM analysis result of a cluster composite according to Example;

FIG. 4B shows an enlarged image of a portion of FIG. 4A;

FIG. 5A shows an SEM analysis result of the cross section of an electrode according to Comparative Example 2;

FIG. 5B shows an SEM analysis result of the cross section of an electrode according to Comparative Example 1;

FIG. 5C shows an SEM analysis result of the cross section of an electrode according to Example;

FIG. 6 shows particle sizes (D50) of the cluster composites according to Example, Comparative Example 1 and Comparative Example 2; and

FIG. 7 shows capacity retentions of all-solid-state batteries according to Example, Comparative Example 1 and Comparative Example 2.

It should be understood that the appended drawings are not necessarily to scale, presenting a somewhat simplified representation of various preferred features illustrative of the basic principles of the invention. The specific design features of the present disclosure as disclosed herein, including, for example, specific dimensions, orientations, locations, and shapes, will be determined in part by the particular intended application and use environment.

In the figures, reference numbers refer to the same or equivalent parts of the present invention throughout the several figures of the drawing.

### DETAILED DESCRIPTION

The above-described objects, other objects, advantages and features of the present disclosure will become apparent from the descriptions of embodiments given hereinbelow with reference to the accompanying drawings. However, the present disclosure is not limited to the embodiments disclosed herein and may be implemented in various different forms. The embodiments are provided to make the description of the present disclosure thorough and to fully convey the scope of the present invention to those skilled in the art.

In the following description of the embodiments, the same elements are denoted by the same reference numerals even when they are depicted in different drawings. In the drawings, the dimensions of structures may be exaggerated compared to the actual dimensions thereof, for clarity of description. In the following description of the embodiments, terms, such as “first” and “second”, may be used to describe various elements but do not limit the elements. These terms are used only to distinguish one element from other elements. For example, a first element may be named a second element, and similarly, a second element may be named a first element, without departing from the scope and spirit of the invention. Singular expressions may encompass plural expressions, unless they have clearly different contextual meanings.

In the following description of the embodiments, terms, such as “including”, “comprising” and “having”, are to be interpreted as indicating the presence of characteristics, numbers, steps, operations, elements or parts stated in the description or combinations thereof, and do not exclude the presence of one or more other characteristics, numbers, steps, operations, elements, parts or combinations thereof, or possibility of adding the same. In addition, it will be understood that, when a part, such as a layer, a film, a region or a plate, is said to be “on” another part, the part may be located “directly on” the other part or other parts may be interposed between the two parts. In the same manner, it will be understood that, when a part, such as a layer, a film, a region or a plate, is said to be “under” another part, the part may be located “directly under” the other part or other parts may be interposed between the two parts.

All numbers, values and/or expressions representing amounts of components, reaction conditions, polymer compositions and blends used in the description are approximations in which various uncertainties in measurement generated when these values are acquired from essentially different things are reflected and thus it will be understood that they are modified by the term “about”, unless stated otherwise. Further, unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

In addition, it will be understood that, if a numerical range is disclosed in the description, such a range includes all continuous values from a minimum value to a maximum value of the range, unless stated otherwise. Further, if such a range refers to integers, the range includes all integers from a minimum integer to a maximum integer, unless stated otherwise. In the present specification, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

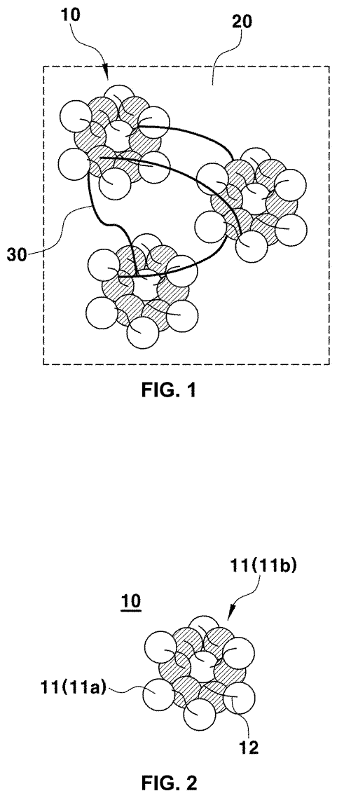

FIG. 1 shows a portion of an exemplary electrode slurry for all-solid-state batteries according to an exemplary embodiment of the present disclosure. The electrode slurry may include a cluster composite 10, a solvent component 20 and a second binder 30.

FIG. 2 shows an exemplary cluster composite according to an exemplary embodiment of the present disclosure. The cluster composite 10 may include an electrode material 11, and a first binder 12 including a fiberized polymer. The electrode material 11 may including a secondary particle 11b, which is an agglomerate of two or more primary particles 11a. The present disclosure is characterized in that the electrode slurry for all-solid-state batteries includes the cluster composite 10 formed by connecting the primary particles 11a by the first binder 12.

When an electrode material, including a nanoscale electrode active material and a nanoscale conductive material, is intactly mixed with a solvent component, a binder, a dispersant, etc., particles of the electrode material are not uniformly dispersed, and are agglomerated into secondary particles. Here, the electrode active material and the conductive material are not uniformly mixed, and particles of the same kind of material are adhered. Further, the electrode material having the nanoscale particles may be intactly used, and thus, viscosity of an acquired slurry may be greatly increased due to a very large surface area of the nanoscale particles. There may have been no choice but to increase the amount of the solvent component in order to reduce viscosity of the slurry, and thus, it takes a long time to form and dry an electrode. Further, a large amount of the solvent component is evaporated, the binder in the electrode is moved in a direction of evaporation of the solvent component, and bonding force between a substrate and the electrode is weakened. Particularly, the binder is locally concentrated upon the surface of the electrode, and thus, resistance of the electrode is increased and electrochemical performance of an all-solid-state battery is reduced.

Meanwhile, when a polymer having a shape of a particle is used as a binder instead of the fiberized polymer, the effective surface area of the binder may not be sufficient, and thus, a large amount of the binder may be required to form the cluster composite. Increase in the content of the binder causes increase in resistance of an electrode, and degrades electrochemical performance of an all-solid-state battery. The polymer having a shape of a particle and having a small effective surface area is not sufficient to prevent aggregating of primary particles, and therefore, the above-described problems still arise.

Thus, in one aspect, provided herein is an electrode material 11 having the form of the secondary particles 11b into which the primary particles 11a agglomerate is used and, in this case, the primary particles 11a are connected by the first binder 12 including the fiberized polymer.

The electrode material may include an electrode active material.

The electrode active material may include a cathode active material or an anode active material.

The cathode active material may include, for example, an oxide active material and a sulfide active material, without being limited to a specific material.

The oxide active material may include a rock salt layer-type active material, such as LiCoO₂, LiMnO₂, LiNiO₂, LiVO₂ or Li₁₊ₓNi_{1/3}Co_{1/3}Mn_{1/3}O₂, a spinel-type active material, such as LiMn₂O₄ or Li(Ni_{0.5}Mn_{1.5})O₄, an inverted spinel-type active material, such as LiNiVO₄ or LiCoVO₄, an olivine-type active material, such as LiFePO₄, LiMnPO₄, LiCoPO₄ or LiNiPO₄, a silicon-containing active material, such as Li₂FeSiO₄ or Li₂MnSiO₄, a rock salt layer-type active material in which a part of a transition metal is substituted with a different kind of metal, such as LiNi_{0.8}Co_{(0.2-x)}AlₓO₂ (0<x<0.2), a spinel-type active material in which a part of a transition metal is substituted with a different kind of metal, such as Li₁₊ₓMn_{2-x-y}M_{y}O₄ (M being at least one of Al, Mg, Co, Fe, Ni or Zn, and 0<x+y<2), or lithium titanate, such as Li₄Ti₅O₁₂.

The sulfide active material may include copper Chevrel, iron sulfide, cobalt sulfide, nickel sulfide or the like.

The anode active material may include, for example, a carbon active material or a metal active material, without being limited to a specific material.

The carbon active material may include mesocarbon microbeads (MCMB), graphite, such as highly oriented pyrolytic graphite (HOPG), or amorphous carbon, such as hard carbon or soft carbon.

The metal active material may include In, Al, Si, Sn, or an alloy including at least one of these elements.

The electrode material may further include a conductive material, a solid electrolyte, etc.

The conductive material may include an SP² carbon material, such as carbon black, conductive graphite, ethylene black or carbon nanotubes, or graphene.

The solid electrolyte may include an oxide-based solid electrolyte or a sulfide-based solid electrolyte. Preferably, a sulfide-based solid electrolyte having high lithium ion conductivity may be used.

The sulfide-based solid electrolyte may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSn (m and n being positive numbers, and Z being one of Ge, Zn and Ga), Li₂S—GeS₂, Li₂S—SiS₂—Li₃PO₄, Li₂S—SiS₂—LiₓMO_{y} (x and y being positive numbers, and M being one of P, Si, Ge, B, Al, Ga and In), or Li₁₀GeP₂S₁₂.

The electrode material may suitably include a carbon material, and metal powder capable of alloying with lithium. The electrode material according to this embodiment may serve to manufacture an anodeless all-solid-state battery.

The carbon material may include one or more amorphous carbons selected from the group consisting of carbon black, furnace black, acetylene black, Ketjen black, and graphene.

The metal powder may include one or more selected from the group consisting of gold (Au), platinum (Pt), palladium (Pd), silicon (Si), silver (Ag), aluminum (Al), bismuth (Bi), tin (Sn), and zinc (Zn).

The particle size (D50) of the primary particles 11a may be about 0.1 nm to 100 nm. Further, the particle size (D50) of the secondary particles 11b may be about 10 to 20 times the particle size (D50) of the primary particles 11a. The particle size (D50) may be defined as a particle size when the portions of particles with diameters less and greater than this value are 50%. The particle size (D50) may be measured using a laser diffraction method. In the laser diffraction method, particle sizes in the range of submicron to several mm may be measured, and results with high reproducibility and high resolution may be acquired.

The first binder 12 may include polytetrafluoroethylene (PTFE). PTFE is a polymer in which hydrogen atoms in polyethylene (PE) are all substituted with fluorine atoms. Although PTFE is a polymer having an aliphatic main chain, PTFE has excellent thermal stability and electrical stability, and is thus applied to the field of electronic materials. PTFE has a cylindrical structure, and is thus capable of being fiberized at a low temperature even though PTFE has a high glass transition temperature.

The cluster composite 10 may include an amount of about 1 part by weight to 5 parts by weight of the first binder 12 based on 100 parts by weight of the electrode material 11. When the content of the first binder 12 is less than about 1 part by weight, adhesive force is not sufficient, and, when the content of the first binder 12 is greater than about 5 parts by weight, the amount of the first binder 12 is large, and thus, the particles may excessively agglomerate, resistance may be increased, and lithium ion conductivity of the electrode may be reduced.

The specific surface area of the cluster composite 100 using the Brunauer, Emmett and Teller (BET) method may be about 0.1 m²/g to 10 m²/g, preferably about 0.5 m²/g to 1 m²/g. The cluster composite 100 having the specific surface area in the above range may improve cohesion between the electrode material 11 and the first binder 12, and may maximally maintain a contact area between particles in the cluster composite 10.

The particle size (D50) of the cluster composite 10 may be about 0.5 μm to 10 μm. When the particle size (D50) of the cluster composite 10 exceeds 10 μm, the content of the first binder 12 may be also increased, and thus, resistance in the electrode may be increased.

The solvent component 20 may include any solvent component which is commonly used in the field to which the present invention pertains, without being limited to a specific solvent. For example, the solvent component 20 may include N-methylpyrrolidone, butyl butyrate, hexyl butyrate, cyclohexanone, toluene, xylene, tetralin, isopropyl alcohol, undecane, dodecane, tridecane, 1,2-octanediol, 1,2-dodecanediol, 1,2-hexadecanediol or the like.

The second binder 30 may be the same as the first binder 12. The second binder 30 may suitably include one or more selected from the group consisting of polyvinylidene fluoride, carboxymethyl cellulose, styrene butadiene rubber, nitrile butadiene rubber, polyacrylic acid, and alginic acid.

The mass ratio of the first binder 12 to the second binder 30 may be about 0.1:100 to 10:1.

The electrode slurry may include the cluster composite 10 including the first binder 12, and may thus reduce the content of the second binder 30, thereby being capable of further increasing capacity characteristics, output characteristics and energy density of the all-solid-state battery.

The electrode slurry may further include a dispersant. The dispersant may be any dispersant which is commonly used in the field to which the present invention pertains. For example, the dispersant may include polyvinyl alcohol, polyvinyl pyrrolidone, Triton X-100, sodium dodecyl sulfate or the like.

Also provided is a method for manufacturing an electrode slurry and the method may include preparing an admixture, e.g., starting material, including a polymer capable of being fiberized and an electrode material, preparing a cluster composite including a first binder including a fiberized polymer and the electrode material by milling, e.g., mechanically, the admixture , and preparing the electrode slurry including the cluster composite, a solvent component and a second binder.

In the mechanically milling of the starting materials, the cluster composite may be manufactured, i.e., the electrode material and the first binder are clustered so as to form a composite other than a mixture by applying energy, and the first binder, which is difficult to distribute, is uniformly distributed. Here, the polymer capable of being fiberized may be fiberized to form the first binder.

Concretely, the admixture may be milled by of the steps including: milling the admixture at a temperature of about 30° C. to 50° C. and a rotational speed of about 100 rpm to 2,000 rpm for about 1 minute to 120 minutes in a dry state, e.g., without using any solvent, and a step of cooling the milled admixture to a temperature of about 1° C. to 30° C. And the step of milling and cooling are repeated plural times.

In the cooling the resultant, the admixture may be in a resting state for about 5 minutes to 12 hours, or the cooled admixture may be stirred at a rotational speed of about 100 rpm to 2,000 rpm for about 1 minute to 10 minutes.

The step of milling and cooling may be repeated about 2 to 50 times.

The producing of the electrode slurry including the prepared cluster composite, the solvent component and the second binder is not limited to a specific method, and, for example, the cluster composite, the solvent component and the second binder may be stirred at a temperature of about 20° C. to 60° C., preferably a temperature of about 30° C. to 45° C. by sonication. Thereby, the electrode slurry in which the cluster composite and the second binder are uniformly dispersed may be acquired.

### EXAMPLE

Hereinafter, the present disclosure will be described in more detail through the following examples. The following examples of the present disclosure serve merely to exemplarily describe the present disclosure, and are not intended to limit the scope of the invention. The examples of the present disclosure are provided to make the description of the present disclosure thorough and to fully convey the scope of the present disclosure to those skilled in the art.

### Example

(Preparation of Cluster Composite) Super C65, as a carbon material, metal powder having a particle size (D50) of 50 nm, and polytetrafluoroethylene (PTFE) powder were input as starting materials to a mechanical mixer, and zirconia balls having a diameter (Φ) of 1 mm were inserted thereinto. The starting materials were mechanically milled by dry ball milling without using any solvent. Concretely, a cluster composite was prepared by repeating milling of the starting materials at a rotational speed of about 2,000 rpm for about 1 minute and cooling of a resultant while stirring the resultant at room temperature (about 25° C.) for about 5 minutes, 5 times. During such a process, a temperature equal to or less than 50° C. was maintained.

(Manufacture of Electrode Slurry and Electrode) An electrode slurry was acquired by inputting the cluster composite and polyvinylidene fluoride (PVDF), as a second binder, to N-methylpyrrolidone, and mixing the respective materials by wet ball milling. Here, the mass ratio of the first binder to the second binder was adjusted to about 2:1. An electrode was manufactured by coating the electrode slurry on a nickel foil.

### Comparative Example 1

A cluster composite was acquired by continuously milling starting materials at a rotational speed of about 2,000 rpm for about 5 minutes without a cooling process. Except for that, the cluster composite, an electrode slurry and an electrode were manufactured in the same manner as in Example.

### Comparative Example 2

An electrode slurry was acquired by inputting super C65, which is a carbon material, metal powder having a particle size (D50) of 50 nm, polyvinylidene fluoride (PVDF), which is a binder, and polyvinyl pyrrolidone, which is a dispersant, to N-methylpyrrolidone, and mixing the respective materials by wet ball milling using zirconia balls having a diameter (Φ) of 1 mm. An electrode was manufactured by coating the electrode slurry on a nickel foil.

### Test Example 1

The cluster composites according to Example and Comparative Example 1 were analyzed using a scanning electron microscope.

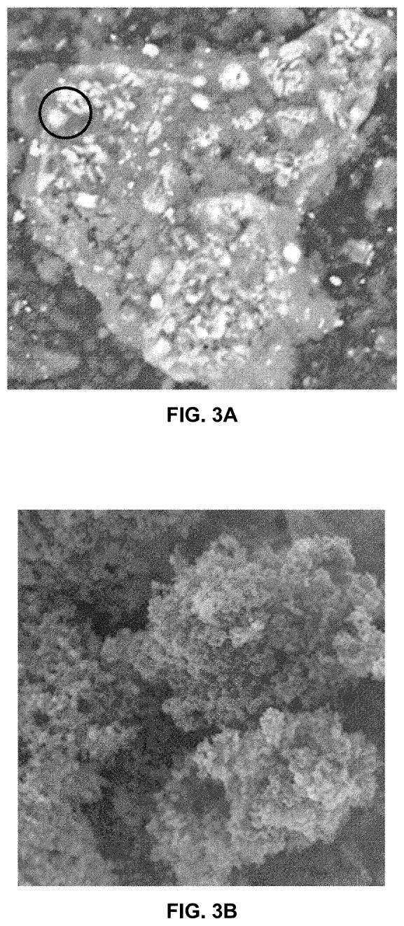

FIG. 3A shows a scanning electron microscope (SEM) analysis result of the cluster composite according to Comparative Example 1. FIG. 3B shows an enlarged image of a portion of FIG. 3A.

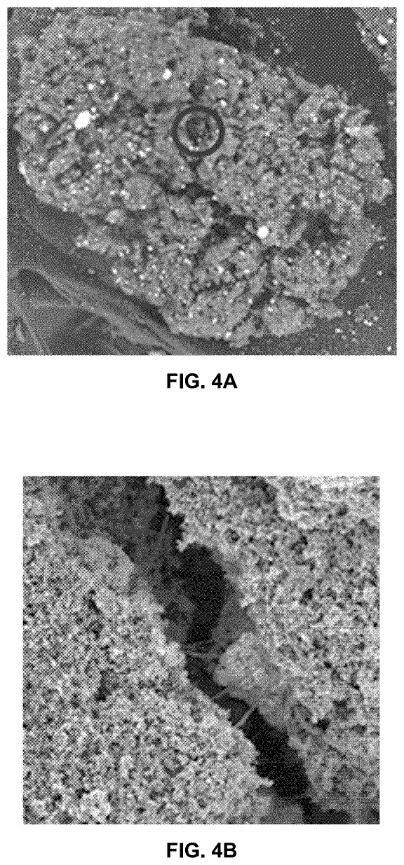

FIG. 4A shows an SEM analysis result of the cluster composite according to Example. FIG. 4B shows an enlarged image of a portion of FIG. 4A.

As shown in FIGS. 3A and 3B, the PTFE powder was not fiberized through the method according to Comparative Example 1. On the other hand, as shown in FIGS. 4A and 4B, the cluster composite according to Example included the fiberized first binder.

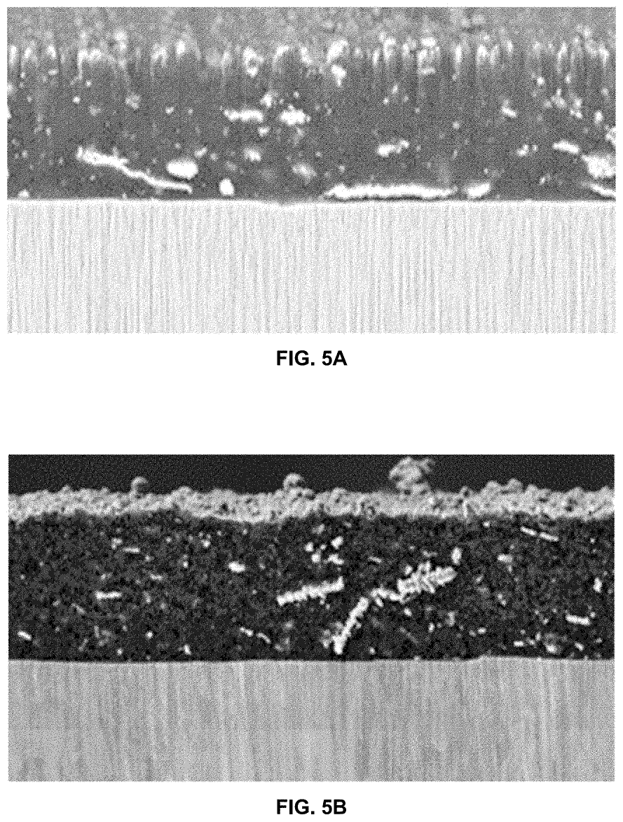

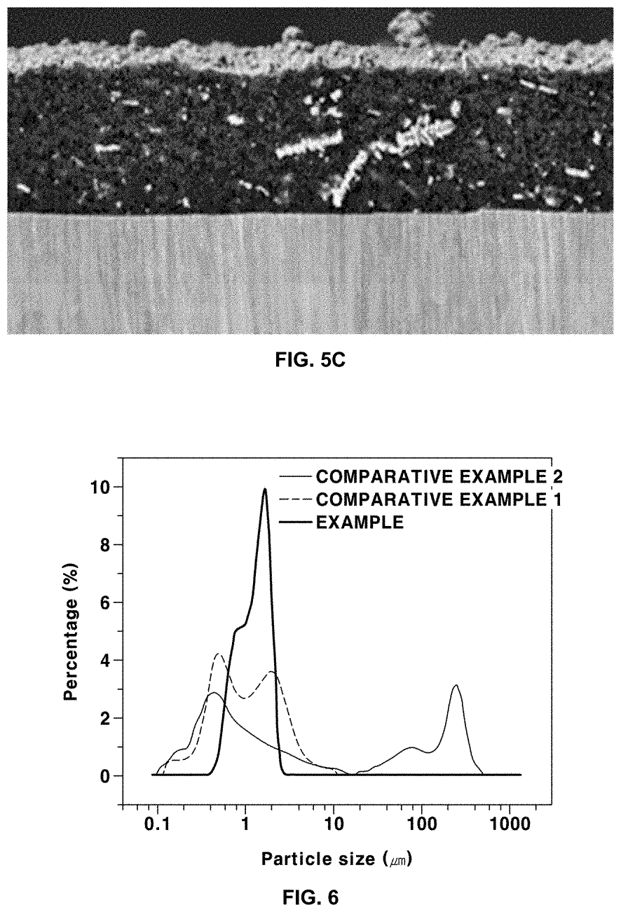

FIG. 5A shows an SEM analysis result of the cross section of the electrode according to Comparative Example 2. FIG. 5B shows an SEM analysis result of the cross section of the electrode according to Comparative Example 1. FIG. 5C shows an SEM analysis result of the cross section of the electrode according to Example.

As shown in FIG. 5A, the electrode according to Comparative Example 2 had a rough surface and exhibited nonuniform sintered shapes and sizes of particles of the metal powder. As shown in FIG. 5B, the electrode according to Comparative Example 1 had a rough surface and exhibited nonuniform sintered shapes and sizes of particles of the metal powder. On the other hand, as shown in FIG. 5C, the electrode according to Example had a comparatively smooth surface and did not exhibit sintering and agglomeration of particles of the metal powder.

### Test Example 2

The particle sizes (D50) of the cluster composites according to Example, Comparative Example 1 and Comparative Example 2 were analyzed. Results are set forth in FIG. 6 and Table 1 below.

TABLE 1

| | Particle size | Polydispersity |
|---|---|---|
| Category | (D50) [μm] | index (PDI) |
| Comparative Example 2 | 1.21 | 0.713 |
| Comparative Example 1 | 0.97 | 0.473 |
| Example | 1.26 | 0.115 |

As shown in FIG. 6 and Table 1, the particle size (D50) distribution of the cluster composite according to Example was uniform compared to the cluster composites according to Comparative Example 1 and Comparative Example 2.

### Test Example 3

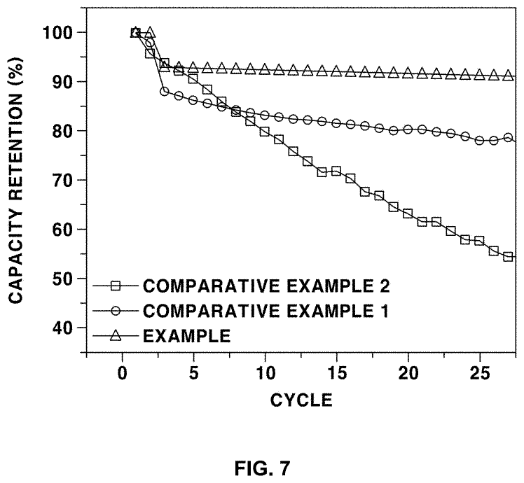

All-solid-state batteries were manufactured by stacking a corresponding one of the electrodes according to Example, Comparative Example 1 and Comparative Example 2, serving as an anode, a cathode including an NCM-based cathode active material, and a solid electrolyte layer including a sulfide-based solid electrolyte, respectively. FIG. 7 shows capacity retentions of the all-solid-state batteries according to Example, Comparative Example 1 and Comparative Example 2. After the all-solid-state batteries were charged and discharged at a current density of 0.1 C in the first two cycles, the capacity retentions of the all-solid-state batteries were evaluated at a current density of 0.3 C in the subsequent cycles.

As shown in FIG. 7, the all-solid-state battery according to Example exhibited excellent capacity retention compared to the all-solid-state batteries according to Comparative Example 1 and Comparative Example 2. Concretely, the all-solid-state battery according to Example retained a capacity of equal to or greater than 90% even after the 25th cycle.

According to various exemplary embodiments of the present disclosure, an electrode slurry for all-solid-state batteries which form an electrode configured such that nanoscale particles of an electrode material are uniformly distributed without using large amounts of a solvent component, a binder, a dispersant, etc. can be provided.

Further, the electrode slurry for all-solid-state batteries according to various exemplary embodiments of the present disclosure may suppress sintering of the nanoscale particles of the electrode material so as to increase performance of a cell.

The invention has been described in detail with reference to exemplary embodiments thereof. However, it will be appreciated by those skilled in the art that changes may be made in these embodiments without departing from the principles and spirit of the invention, the scope of which is defined in the appended claims and their equivalents.

What is claimed is:

1. An electrode slurry for all-solid-state batteries, comprising:
a cluster composite comprising a first binder comprising a fiberized polymer, and an electrode material;
a solvent component; and
a second binder.

2. The electrode slurry of claim 1, wherein the cluster composite comprises:
the electrode material comprising a secondary particle comprising a plurality of primary particles, wherein a size of each primary particle is in nanometer scale; and
the first binder connecting the primary particles.

3. The electrode slurry of claim 1, wherein the electrode material comprises an electrode active material.

4. The electrode slurry of claim 1, wherein the electrode material comprises:
a carbon material; and
a metal powder capable of alloying with lithium,
wherein the metal powder comprises one or more selected from the group consisting of gold (Au), platinum (Pt), palladium (Pd), silicon (Si), silver (Ag), aluminum (Al), bismuth (Bi), tin (Sn), and zinc (Zn).

5. The electrode slurry of claim 1, wherein the first binder comprises polytetrafluoroethylene.

6. The electrode slurry of claim 1, wherein the cluster composite comprises an amount of about 1 part by weight to 5 parts by weight of the first binder based on 100 parts by weight of the electrode material.

7. The electrode slurry of claim 1, wherein a particle size (D50) of the cluster composite is about 0.5 μm to 10 μm.

8. The electrode slurry of claim 1, wherein:
the second binder is the same as the first binder; or
the second binder comprises one or more selected from the group consisting of polyvinylidene fluoride, carboxymethyl cellulose, styrene butadiene rubber, nitrile butadiene rubber, polyacrylic acid, and alginic acid.

9. The electrode slurry of claim 1, wherein a mass ratio of the first binder to the second binder is about 0.1:100 to 10:1

10. A method for manufacturing an electrode slurry for all-solid-state batteries, comprising:
providing an admixture comprising a polymer capable of being fiberized and an electrode material;
preparing a cluster composite comprising a first binder comprising a fiberized polymer, and the electrode material by milling the admixture; and
producing the electrode slurry comprising the cluster composite, a solvent component and a second binder.

11. The method of claim 10, wherein the milling comprises steps of:
milling of the admixture at a temperature of about 30° C. to 50° C. and a rotational speed of about 100 rpm to 2,000 rpm for about 1 minute to 120 minutes in a dry state, and
cooling of the admixture to a temperature of about 1° C. to 30° C., and
wherein the milling and cooling are repeated.

12. The method of claim 11, wherein the cooling of the admixture comprises:
after the milling, resting the admixture for about 5 minutes to 12 hours; or
stirring the admixture at a rotational speed of about 100 rpm to 2,000 rpm for about 1 minute to 10 minutes.

13. The method of claim 11, wherein the milling and the cooling are repeated about 2 to 50 times.

14. The method of claim 10, wherein the cluster composite comprises:
the electrode material comprising at least one secondary particle comprising a plurality of primary particles, wherein a size of each primary particle is in nanometer scale; and
the first binder connecting the primary particles.

15. The method of claim 10, wherein the electrode material comprises an electrode active material.

16. The method of claim 10, wherein the electrode material comprises:
a carbon material; and
metal powder capable of alloying with lithium,
wherein the metal powder comprises one or more selected from the group consisting of gold (Au), platinum (Pt), palladium (Pd), silicon (Si), silver (Ag), aluminum (Al), bismuth (Bi), tin (Sn), and zinc (Zn).

17. The method of claim 10, wherein the first binder comprises polytetrafluoroethylene.

18. The method of claim 10, wherein the cluster composite comprises an amount of about 1 part by weight to 5 parts by weight of the first binder based on 100 parts by weight of the electrode material.

19. The method of claim 10, wherein a particle size (D50) of the cluster composite is about 0.5 μm to 10 μm.

20. The method of claim 10, wherein:
the second binder is the same as the first binder; or
the second binder comprises one or more selected from the group consisting of polyvinylidene fluoride, carboxymethyl cellulose, styrene butadiene rubber, nitrile butadiene rubber, polyacrylic acid, and alginic acid; and
wherein a mass ratio of the first binder to the second binder is about 0.1:100 to 10:1.
